(19) United States
(12) Patent Application Publication
(10) Pub. No.: US 2025/0231557 A1
(43) Pub. Date: Jul. 17, 2025

(54) ASSEMBLY DIAGNOSIS SYSTEM AND ASSEMBLY DIAGNOSIS METHOD

(71) Applicant: DENSO CORPORATION, Kariya-city (JP)

(72) Inventors: Sho MATSUMOTO, Kariya-city (JP); Tomohisa KISHIGAMI, Kariya-city (JP)

(21) Appl. No.: 18/966,549

(22) Filed: Dec. 3, 2024

(30) Foreign Application Priority Data
Jan. 15, 2024 (JP) 2024-004066

(51) Int. Cl. G05B 23/02; B60R 16/03

(52) U.S. Cl. CPC G05B 23/0245; B60R 16/03

(57) ABSTRACT

An electric power is supplied to a slave ECU by a master ECU turning on a switch provided in a power supply line of the slave ECU. An activation notification message including an identifier of the slave ECU is transmitted to a communication network to which the master ECU and the slave ECU are connected when the slave ECU receives electric power supply and is activated. It is diagnosed whether the at least one slave ECU has been properly assembled based on the activation notification message transmitted to the communication network.

### CROSS REFERENCE TO RELATED APPLICATION

The present application claims the benefit of priority from Japanese Patent Application No. 2024-004066 filed on Jan. 15, 2024. The entire disclosure of the above application is incorporated herein by reference.

### TECHNICAL FIELD

The present disclosure relates to an assembly diagnosis system and an assembly diagnosis method for diagnosing whether or not a slave ECU, the power supply of which is controlled by a master ECU, has been properly assembled.

### BACKGROUND ART

For example, a conceivable technique teaches a vehicle communication system in which multiple control devices mounted on a vehicle are connected with each other via a data communication network, and each control device is configured to transmit and receive data to and from each other via the network.

### SUMMARY OF INVENTION

According to an example, an electric power is supplied to a slave ECU by a master ECU turning on a switch provided in a power supply line of the slave ECU. An activation notification message including an identifier of the slave ECU is transmitted to a communication network to which the master ECU and the slave ECU are connected when the slave ECU receives electric power supply and is activated. It is diagnosed whether the at least one slave ECU has been properly assembled based on the activation notification message transmitted to the communication network.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing the overall configuration of an in-vehicle system to which an assembly diagnosis system according to a first embodiment is applied;

FIG. 2 is a flowchart showing an assembly diagnosis process executed by cooperation between a master ECU and a slave ECU in the first embodiment;

FIG. 3 is a diagram showing a table of an example of identifiers of each slave ECU and a result of the assembly diagnosis stored to be linked to the numbers of the relay switch and the electric power port;

FIG. 4 is a time chart for explaining an example of the operation of a master ECU and a slave ECU according to the process of the flowchart of FIG. 2;

FIG. 5 is a diagram showing the overall configuration of an in-vehicle system to which an assembly diagnosis system according to a second embodiment is applied;

FIG. 6 is a flowchart showing an example of an assembly diagnosis process executed in an assembly diagnosis system according to a second embodiment;

FIG. 7 is a time chart for explaining an example of the operation of the master ECU, the slave ECU, and the notification ECU in accordance with the process of the flowchart of FIG. 6;

FIG. 8 is a flowchart showing an example of an assembly diagnosis process executed in an assembly diagnosis system according to a third embodiment;

FIG. 9 is a diagram showing a table of an example in which the identifier of the slave ECU that has been properly assembled is stored in association with the numbers of the respective relay switch and the electric power port;

FIG. 10 is a flowchart showing a process executed by each ECU when the ECU assembled on a vehicle is operated in the third embodiment;

FIG. 11 is a time chart for explaining an example of the operation of the master ECU, the slave ECU, and another ECU in accordance with the process of the flowchart of FIGS. 8 and 10;

FIG. 12 is a flowchart showing an example of an assembly diagnosis process executed in an assembly diagnosis system according to a fourth embodiment;

FIG. 13 is a time chart showing an example of the operation of the master ECU and the slave ECU in accordance with the process of the flowchart of FIG. 12;

FIG. 14 is a diagram showing the overall configuration of an in-vehicle system to which an assembly diagnosis system according to a fifth embodiment is applied;

FIG. 15 is a diagram showing a table for explaining a candidate list of optional ECUs that is stored in association with the third relay switch and the third electric power port;

FIG. 16 is a flowchart showing an example of an assembly diagnosis process executed in an assembly diagnosis system according to a fifth embodiment; and

FIG. 17 is a diagram showing a table of an example in which the identifier of the slave ECU that has been properly assembled, including learning diagnostics factor for optional ECUs, are stored in association with the numbers of each relay switch and electric power port.

### DETAILED DESCRIPTION

When establishing a system constituted by a plurality of control devices (i.e., ECUs) according to the conceivable technique, it is required to reduce power consumption of the entire system. For this reason, for example, it is conceivable that at least one ECU (i.e., master ECU) can control whether or not electric power is supplied to at least one ECU (i.e., slave ECU). Thus, it is possible for the master ECU to supply the electric power to the slave ECU only when an operation of the slave ECU is required, and to cut off the electric power supply to the slave ECU when the operation of the slave ECU is not required. As a result, it is possible to cut off the dark current when the operation of the slave ECU is not required, and it is possible to achieve further power saving in the entire system.

Here, as described above, when the master ECU is configured to control whether or not to supply the electric power to the slave ECU, the slave ECU that is set as the control target for which the master ECU controls the electric power supply needs to be properly assembled without being mistaken for another type of slave ECU and connection to the power supply line through which the electric power supply is controlled by the master ECU. However, during the ECU assembly process, there is a possibility that an ECU other than the scheduled slave ECU will be mistakenly assembled. Furthermore, the assembly process of the slave ECU itself, including the connection to the power supply line, may not be always performed properly.

The present disclosure has been made in consideration of the above-described points, and aims to provide an assembly diagnosis system and an assembly diagnosis method capable of diagnosing whether or not a slave ECU, power supply of which is controlled by a master ECU, has been properly assembled.

In order to achieve the above object, the assembly diagnosis system according to the present disclosure includes: a master ECU; at least one slave ECU that transmits an activation notification message including an identifier of the at least one slave when the at least one slave ECU is activated; a switch provided in a power supply line of the at least one slave ECU; and a diagnosis unit.

The master ECU has a function of turning the switch on and off, and can control whether or not electric power is supplied to the slave ECU. When the slave ECU receives electric power supply and is activated, the slave ECU transmits an activation notification message to a communication network to which the master ECU and the slave ECU are connected. The diagnosis unit diagnoses whether or not the slave ECU has been properly assembled based on the activation notification message transmitted to the communication network.

Further, the assembly diagnosis method according to the present disclosure includes: supplying electric power to a slave ECU by a master ECU turning on a switch provided in a power supply line of the slave ECU; transmitting an activation notification message including an identifier of the slave ECU to a communication network to which the master ECU and the slave ECU are connected when the slave ECU receives electric power supply and is activated; and diagnosing whether or not the slave ECU has been properly assembled based on the activation notification message transmitted to the communication network by a diagnosis unit.

According to the above-described assembly diagnosis system and assembly diagnosis method, the slave ECU that is supplied with the electric power under the control of the master ECU transmits the activation notification message including the identifier of the slave ECU to the communication network when the slave ECU is activated. The activation notification message includes the identifier of the slave ECU. Therefore, the diagnosis unit can determine, based on the identifier, whether or not the slave ECU that transmitted the activation notification message is the slave ECU that is scheduled to be assembled.

Furthermore, when it is determined whether or not the slave ECU that is scheduled to be assembled is the slave ECU based on the identifier included in the activation notification message transmitted from the slave ECU, in addition to a condition that there is no mistake in the type of assembled ECU, since the slave ECU activated normally and is able to transmit the activation notification message normally, so that the diagnosis unit can diagnose that the connection of the slave ECU to the power supply line and the connection to the communication network are also performed properly without any errors.

In this manner, the diagnosis unit is able to diagnose whether or not the slave ECU has been properly assembled based on the activation notification message transmitted to the communication network.

The reference signs and/or numerals in parentheses are merely added to indicate examples of correspondence relationships with concrete structures in the below-described embodiments in order to facilitate the understanding of the present disclosure, which has no intention to limit the scope of the present disclosure in any manner.

Hereinafter, an embodiment of an assembly diagnosis system and an assembly diagnosis method according to the present disclosure will be described with reference to the drawings. In the following description of the embodiments, the same or similar components may be denoted by the same reference numerals throughout the drawings, and the description thereof may be omitted. When only a part of a configuration is described in each embodiment, a configuration of another embodiment described earlier can be applied to the other part of the configuration. In addition to the combination of the configurations explicitly described in the description of each embodiment, the configurations of multiple embodiments may be partially combined even if not explicitly described as long as there is no difficulty in the combination.

### First Embodiment

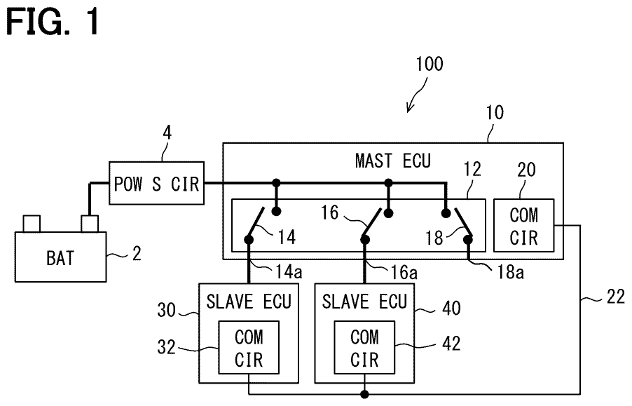

FIG. 1 is a diagram showing the overall configuration of an in-vehicle system to which an assembly diagnosis system 100 according to a present embodiment is applied. As shown in FIG. 1, the assembly diagnosis system 100 according to the present embodiment can be applied to, for example, an in-vehicle system constructed in a vehicle in which a plurality of electronic control units (i.e., ECUs) are connected to a network. In this case, the components of the assembly diagnosis system 100 are mounted on the vehicle. Here, application examples of the assembly diagnosis system 100 according to the present disclosure may not be limited to in-vehicle systems, and the system may be applied to other applications. For example, the assembly diagnosis system 100 according to the present disclosure can be applied to a control system for a robot or construction machine that includes a plurality of control devices connected to a network.

As shown in FIG. 1, the assembly diagnosis system 100 according to the present embodiment includes a master ECU 10 and a plurality of first and second slave ECUs 30, 40. Here, the number of slave ECUs 30, 40 may not be limited to two, and may be one, or three or more.

The master ECU 10 and the first and second slave ECUs are general-purpose computers and include processors such as a CPU and a GPU, a volatile memory such as a RAM, and a storage that is a non-volatile storage medium such as a ROM or a flash memory. The storage stores various programs executed by the processor. For example, the storage of the master ECU 10 stores an assembly diagnosis program, which will be described later. The execution of the assembly diagnosis program by the processor of the master ECU 10 corresponds to the execution of an assembly diagnosis method corresponding to the assembly diagnosis program by the master ECU 10.

The storage of the master ECU 10 also stores information indicating a unique identifier of a slave ECU that is scheduled to be connected, in association with the number of a relay switch or the number of an electric power port of a relay circuit 12 described later. Furthermore, the storages of the first and second slave ECUs 30, 40 store information indicating their own identifiers, respectively.

The master ECU 10 includes a relay circuit 12 and a communication circuit 20. The relay circuit 12 includes a plurality of first, second and third relay switches 14, 16, 18. The relay switches 14, 16, and 18 are provided on power supply lines for supplying electric power to the slave ECUs 30 and 40, respectively. The electric power acquired by converting the power source voltage of a battery 2 mounted on the vehicle into an operating voltage for the master ECU 10 and the slave ECUs 30 and 40 by a power supply circuit 4 is supplied through the electric power supply line. The master ECU 10 and the first and second slave ECUs 30, 40 operate using the electric power supplied from a power supply line.

Each of the relay switches 14, 16, and 18 can be configured by a semiconductor switch such as a MOSFET or an IGBT. Here, each of the relay switches 14, 16, and 18 may be configured by a normal mechanical relay instead of a semiconductor switch. The relay circuit 12 may be provided inside the master ECU 10 as shown in FIG. 1, or may be provided outside the master ECU 10.

The master ECU 10 has a function of controlling whether or not the electric power is supplied to each of the slave ECUs 30 and 40. This function may be realized by software such as a power supply control program, or may be realized by hardware. More specifically, the master ECU 10 turns on the relay switches 14, 16 corresponding to the slave ECUs 30, 40 only when the operation of the slave ECUs 30, 40 is required. Conversely, when the operation of each of the slave ECUs 30, 40 is unnecessary, the master ECU 10 turns off each of the relay switches 14, 16 corresponding to each of the slave ECUs 30, 40. Thus, it is possible to execute the electric power to be supplied to each of the slave ECUs 30, 40 only when the operation of the slave ECUs 30, 40 is required, and when the operation of the slave ECUs 30, 40 is not required, the electric power supply to each of the slave ECUs 30, 40 can be cut off. As a result, it is possible to cut off the dark current when the operation of each slave ECUs 30, 40 is not required, and it is possible to achieve further power saving in the entire system.

The communication circuit 20 is connected to a communication network 22 and is capable of receiving a message transmitted from another ECU and the like via the communication network 22, and transmitting a message to the communication network 22 toward another ECU and the like. In the communication network 22, the message is transmitted and received conforming to, for example, the CAN (registered trademark, the same applies below) protocol. When a CAN message is transmitted or received over the communication network 22, the communication circuit 20 performs a reception process when the CAN message is stored in a reception buffer. This reception process includes a process of determining whether or not the received message is an improper message through a form check, a cyclic redundancy check, or the like. Then, only when the communication circuit 20 determines that the message is proper, the communication circuit 20 passes various information, such as data, included in the message to the processor of the master ECU 10. Furthermore, when a message to be transmitted is stored in the transmission buffer, the communication circuit 20 performs a transmission process to transmit the message to the communication network 22 while arbitrating with transmission signals from other ECUs. Here, the communication protocol may not be limited to the CAN protocol, and may be other communication protocols such as LIN, FlexRay (registered trademark), and Ethernet (registered trademark). Furthermore, when multiple networks including the communication network 22 are connected via a relay device such as a gateway, different communication protocols may be adopted in the multiple networks. In this case, the relay device is configured to have a conversion function for converting the protocol of a message when the message is transferred between networks having different communication protocols.

In addition to the master ECU 10 and the slave ECUs 30 and 40, another ECU (not shown) is also connected to the communication network 22. The slave ECUs 30, 40 and another ECU may be connected to the communication network 22, or may be connected to another network that is connected to the communication network 22 via a relay device. Therefore, the master ECU 10 can use the communication circuit 20 to transmit and receive various messages to and from the slave ECUs 30 and 40 and another ECU that are directly or indirectly connected to the communication network 22.

Similar to the master ECU 10, the first and second slave ECUs 30, 40 each include a communication circuit 32, 42, respectively. The communication circuits 32, 42 of the first and second slave ECUs 30, 40 have the same message transmission and reception function as the communication circuit 20 of the master ECU 10. Therefore, the first and second slave ECUs 30, 40 can also use the communication circuits 32, 42 to transmit and receive various messages to and from each ECU connected to the communication network 22.

When the first slave ECU 30 is assembled in a vehicle, the power line of the first slave ECU 30 is connected to the first power port 14a connected to the first relay switch 14 of the relay circuit 12, and the communication network 22 is connected to the connection port of the communication circuit 32. Similarly, when the second slave ECU 40 is assembled into the vehicle, the power line of the second slave ECU 40 is connected to the second power port 16a connected to the second relay switch 16 of the relay circuit 12, and the communication network 22 is connected to the connection port of the communication circuit 42. The third relay switch 18 of the relay circuit 12 and the third power port 18a connected to the third relay switch 18 are used when an optional ECU is connected. In the example shown in FIG. 1, no optional ECU is connected.

The first and second slave ECUs 30, 40 is configured to control target devices (e.g., a door lock mechanism, a power window drive motors, a headlight light source, a wiper motor, AV equipment, and the like) that are controlled by the ECU only when a specific condition is satisfied or under a specific circumstance among various control target devices mounted on the vehicle. For example, the door lock mechanism is controlled by a door lock control ECU when an user of the vehicle gets into the vehicle or gets out of the vehicle. The drive motor of the power window is controlled by an ECU for controlling the power window when an user operates a window up/down switch.

In this manner, the first and second slave ECUs 30, 40 control the control target devices that operate only when a specific condition is satisfied or under a specific circumstance. Therefore, as a general rule, when the operation of the first and second slave ECUs 30, 40 is required, the master ECU 10 turns on the first and second relay switches 14, 16 corresponding to the first and second slave ECUs 30, 40 to supply the electric power to the first and second slave ECUs 30, 40. On the other hand, when the operation of the first and second slave ECUs 30, 40 is not required, the master ECU 10 turns off the first and second relay switches 14, 16 corresponding to the first and second slave ECUs 30, 40 to stop supplying the electric power to the first and second slave ECUs.

In addition to the function of controlling whether or not the electric power is supplied to the first and second slave ECUs 30, 40 described above, the master ECU 10 also has the function of diagnosing whether the first and second slave ECUs 30, 40 have been assembled properly, as described above. Therefore, the storage of the master ECU 10 can store a power supply control program, an assembly diagnosis program, and the like. Furthermore, similar to the first and second slave ECUs 30 and 40, the master ECU 10 may also control the control target devices that are mounted on the vehicle. In this case, the storage of the master ECU 10 also stores a control program for controlling the control target devices.

Here, if the control target devices of the first and second slave ECUs 30, 40 are different, the timing at which the control target devices are controlled will also be different, and therefore the master ECU 10 will supply the electric power to each of the first and second slave ECUs 30, 40 at different times and stop supplying the electric power to each of the first and second slave ECUs 30, 40 at different times. Therefore, the electric power port numbers of the relay circuits 12 to which the respective power lines of the first and second slave ECUs 30, 40 should be connected are determined in advance. In the example shown in FIG. 1, the power line of the first slave ECU 30 is scheduled to be connected to the first power port 14a of the relay circuit 12, and the power line of the second slave ECU 40 is scheduled to be connected to the second power port 16a of the relay circuit 12. Therefore, the first and second slave ECUs 30, 40 need to be properly assembled with their respective power lines connected to predetermined power ports and without being confused with other types of slave ECUs.

However, during the assembly work of the first and second slave ECUs 30, 40, there is a possibility that an ECU other than the scheduled slave ECU may be mistakenly assembled. Furthermore, the assembly work of the first and second slave ECUs 30, 40 itself may not be always performed properly, and there is a possibility that a difficulty may occur during the assembly work. Such faults of the assembly work include a connection fault of the power lines of the slave ECUs 30, 40 to the power ports of the relay circuit 12, a connection fault to the communication network 22, and the like.

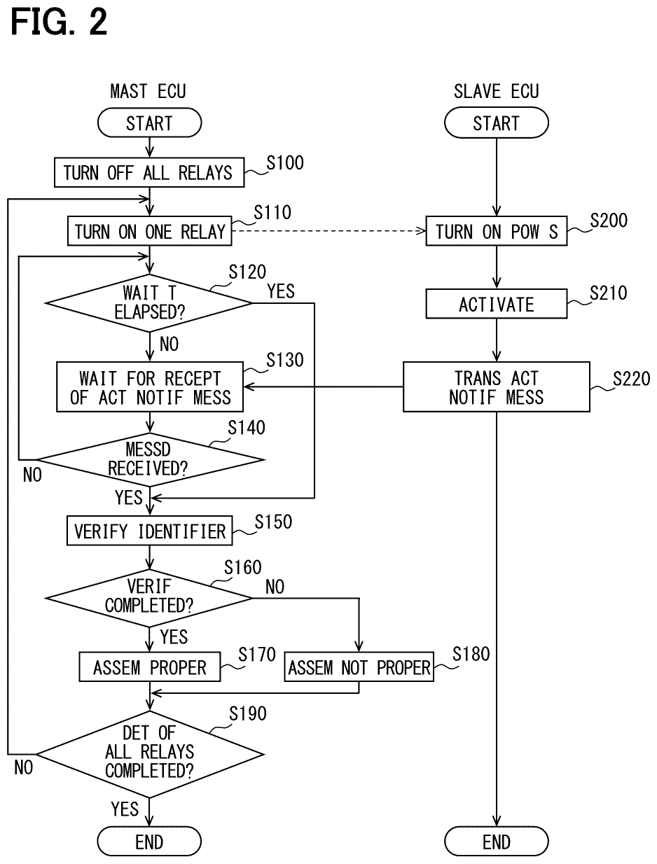

Therefore, in this embodiment, as described above, the master ECU 10 is provided with a function for diagnosing whether or not the first and second slave ECUs 30, 40 have been assembled properly. The assembly diagnosis process executed by the master ECU 10 and the slave ECUs 30 and 40 in cooperation with each other will be described in detail below with reference to the flowchart of FIG. 2. The process shown in the flowchart in FIG. 2 may be executed in response to a predetermined instruction (e.g., an instruction to start diagnosis) as a trigger to the master ECU 10 after the assembly work of the master ECU 10 and the first and second slave ECUs 30, 40 into the vehicle is completed.

In the first step S100, the master ECU 10 turns off all the relay switches 14, 16, 18 in the relay circuit 12. In the next step S110, the master ECU 10 turns on one of the relay switches 14, 16, 18 in a predetermined order. As a result, as shown in step S200, the electric power supply to the first or second slave ECU 30, 40 corresponding to the relay switch 14, 16, 18 that is turned on is started.

In step S120, the master ECU 10 determines whether or not a standby time has elapsed since the start of the power supply to the first or second slave ECU 30, 40. The standby time is set to a time longer than the time from when the electric power supply to the first or second slave ECU 30, 40 starts to when the first or second slave ECU 30, 40 completes activation and transmits the activation notification message. If it is determined that the standby time has not elapsed, the master ECU 10 proceeds to the process of step S130. If it is determined that the standby time has elapsed, the master ECU 10 proceeds to the process of step S150. In step S130, the master ECU 10 waits for reception of the activation notification message from the first or second slave ECU 30, 40, and performs a reception process when the activation notification message is received.

When the corresponding relay switch 14, 16, 18 is turned on and the electric power supply is started in step S200, the first or second slave ECU 30, 40 executes an activation process in step S210. This activation process includes, for example, the initialization of various variables and the activation of various programs. Then, when the activation process is completed, the first or second slave ECU 30, 40 transmits the activation notification message indicating that the first or second slave ECU 30, 40 has been activated in step S220. This activation notification message includes information indicating the identifier of the first or second slave ECU 30, 40.

The time from when the electric power supply to the first or second slave ECU 30, 40 is started until the first or second slave ECU 30, 40 completes the activation process and transmits the activation notification message is substantially constant. As described above, the standby time is set to a time longer than the time from the start of the electric power supply to the first or second slave ECU 30, 40 to the transmission of the activation notification message. Therefore, when the master ECU 10 turns on one of the relay switches 14, 16, the electric power is actually supplied to the first or second slave ECU 30, 40, and if the first or second slave ECU 30, 40 is connected to the communication network 22, the activation notification message should be transmitted from the first or second slave ECU 30, 40 to the communication network 22 within the standby time. For this reason, when the master ECU 10 receives a activation notification message from the first or second slave ECU 30, 40 in step S130, the master ECU 10 can determine that there is no fault for the first or second slave ECU 30, 40 in the connection of the power line to the power port 14a, 16a, 18a and the connection of the communication network 22 to the connection port of the communication circuit 32, 42.

In step S140, the master ECU 10 determines whether or not the activation notification message has been received. If it is determined that the activation notification message has not yet been received, the master ECU 10 returns to the process of step S120. At this time, if it is determined in step S120 that the waiting time has elapsed, the master ECU 10 can determine that there has been some fault for the first or second slave ECU 30, 40 in the connection of the power line to the power port 14a, 16a, 18a and/or the connection of the communication network 22 to the connection port of the communication circuit 32, 42.

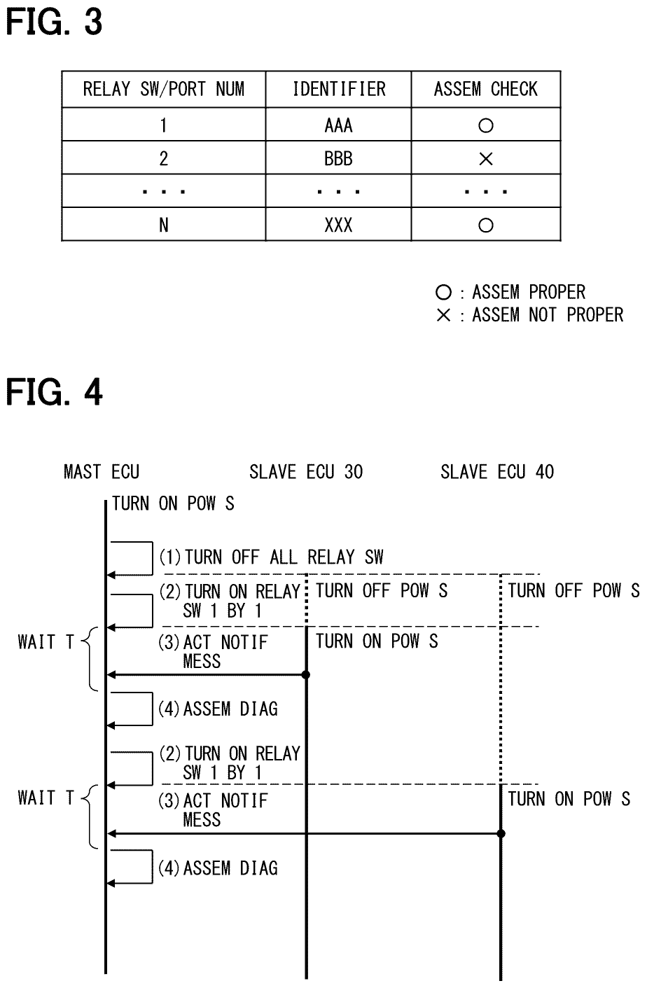

In step S150, the master ECU 10 refers to information preliminarily stored in the storage indicating the identifier of the slave ECU 30, 40 that is scheduled to be connected and that is linked to the number of the relay switch 14, 16, 18 or the number of the power port 14a, 16a, 18a, and specifies the identifier of the slave ECU 30, 40 that corresponds to one of the relay switches 14, 16, 18 that has been turned on in step S120. Then, the master ECU 10 verifies the identifier of the specified slave ECUs 30 and 40 with the identifier included in the received activation notification message. For example, as shown in the table of FIG. 3, if the identifier of “AAA” is linked to the first relay switch 14 that is turned on one by one in a specified order, and if the relay switch 14 that is turned on is the first one, the master ECU 10 verifies the identifier of “AAA” with the identifier included in the received activation notification message.

In step S160, the master ECU 10 determines whether the verification result of the identifier in step S150 is proper or not. Specifically, if the verified identifiers match, the master ECU 10 determines that the verification result is proper, and if the verified identifiers do not match, the master ECU 10 determines that the verification result is not proper. If the master ECU 10 determines that the verification result is proper, the master ECU 10 can determine that the slave ECU 30, 40 that is scheduled to be connected to the one relay switch 14, 16, 18 that is turned on is properly assembled without any mistake in type. Therefore, if the verification result is determined to be proper, the master ECU 10 proceeds to the process of step S170 and determines that the assembly is proper. This determination result (i.e., the assembly diagnosis result) is stored in association with the numbers of the relay switches 14, 16, 18 or the numbers of the power ports 14a, 16a, 18a and/or the identifiers of the slave ECUs 30, 40, as shown in FIG. 3.

On the other hand, if the master ECU 10 determines in step S160 that the verification result is not proper, there is a high possibility that a slave ECU of a different type from the slave ECU 30, 40 that is scheduled to be connected to the one relay switch 14, 16, 18 that is turned on has been mistakenly assembled. Therefore, if the verification result is determined to be not proper, the master ECU 10 proceeds to the process of step S180 and determines that the assembly is not proper. This determination result (i.e., the assembly diagnosis result) is stored in association with the numbers of the relay switches 14, 16, 18 or the numbers of the power ports 14a, 16a, 18a and/or the identifiers of the slave ECUs 30, 40, as shown in FIG. 3.

If the activation notification message is not received within the waiting time, the master ECU 10 also determines in step S160 that the verification result is not proper because the identifier to be verified is not acquired. In this case, the master ECU 10 also determines in step S170 that the assembly is not proper. When storing this determination result, it may be preferable to also store the feature that the activation notification message has not been received. As a result, for example, by using a diagnosis result reading device connected to the communication network 22 or the master ECU 10 to read out the determination result from the master ECU 10 as to whether the assembly is proper or not, it is possible to identify the ECU for which the assembly is not proper, and further to easily specify the reason why the assembly is not proper.

In step S190, the master ECU 10 determines whether or not the determination as to whether the assembly is proper or not has been completed for all of the relay switches 14, 16, 18. If the determination has not been completed for all of the relay switches 14, 16, 18, the master ECU 10 returns to step S110, changes the relay switches 14, 16, 18 to be turned on in a predetermined order, and repeats the processes from step S120. On the other hand, if the determination has been completed for all of the relay switches 14, 16, 18, the master ECU 10 ends the process shown in the flowchart of FIG. 2.

Next, an example of the operation of the master ECU 10 and the first and second slave ECUs 30, 40 according to the process of the flowchart in FIG. 2 will be described with reference to a time chart in FIG. 4.

As shown in FIG. 4, the master ECU 10 first turns off all the relay switches 14, 16, 18 in the relay circuit 12. As a result, the electric power is not supplied to the first and second slave ECUs 30, 40 connected to the relay circuit 12, and the power source is turned off.

Next, the master ECU 10 turns on the relay switches 14, 16, and 18 one by one in a predetermined order. In the example shown in FIG. 4, first, the first relay switch 14 is turned on, the power source to the first slave ECU 30 is turned on, and the electric power is supplied to the first slave ECU 30. When the power source of the first slave ECU 30 is turned on and the activation process is completed, the first slave ECU 30 transmits the activation notification message to the communication network 22.

The master ECU 10 waits for receipt of the activation notification message from the first slave ECU 30 during the standby time. If the first slave ECU 30 transmits the activation notification message before the waiting time ends, the master ECU 10 receives the activation notification message from the first slave ECU 30 using the communication circuit 20. Thereafter, the master ECU 10 verifies the identifier of the slave ECU 30 stored to be linked to the first relay switch 14 with the identifier included in the received activation notification message, and performs an assembly diagnosis based on the verification result to determine whether the assembly is proper or not.

Thereafter, the master ECU 10 repeats the above-described process while turning on all of the relay switches 16, 18 one by one in order, to diagnose whether or not all of the slave ECUs 30, 40, including the optional ECUs, have been properly assembled.

In the example shown in FIG. 4, the power source to the first slave ECU 30 is maintained to turn on after the assembly diagnosis of the first slave ECU 30 is completed, alternatively, the power source to the first slave ECU 30 may be turned off after the assembly diagnosis is completed.

### Second Embodiment

Next, an assembly diagnosis system and an assembly diagnosis method according to a second embodiment of the present disclosure will be described with reference to the drawings.

In the first embodiment described above, the master ECU 10 determines whether or not the assembly of each slave ECU 30, 40 has been performed properly, and stores the assembly diagnosis result as the determination result in association with the numbers of the relay switches 14, 16, 18 or the numbers of the power ports 14a, 16a, 18a, and/or the identifiers of the slave ECUs 30, 40. In this case, to check the assembly diagnosis result, for example, a diagnosis result reading device must be connected to the communication network 22 or the master ECU 10 and the diagnosis result reading device must read the assembly diagnosis result from the master ECU 10.

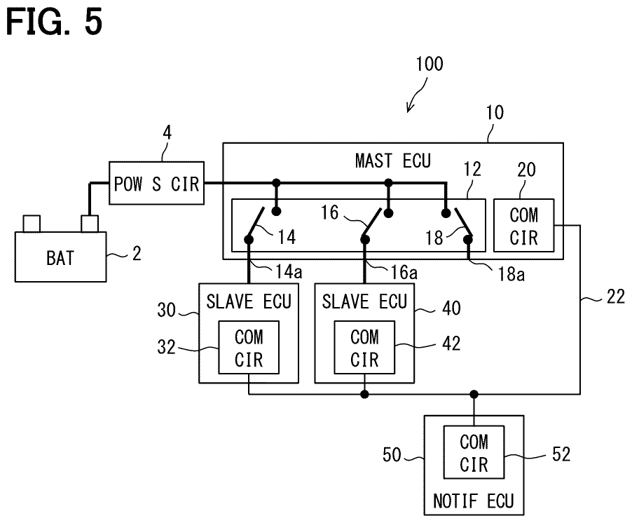

In contrast, in the assembly diagnosis system and the assembly diagnosis method according to this embodiment, as shown in FIG. 5, a notification ECU 50 having a function of notifying a user of a diagnosis result is connected to the communication network 22 via a communication circuit 52. The communication circuit 52 of the notification ECU 50 has a message transmission and reception function similar to that of the communication circuit 20 of the master ECU 10. Therefore, the notification ECU 50 can also use the communication circuit 52 to transmit and receive various messages to and from each ECU connected to the communication network 22. The notification ECU 50 may be one of the slave ECUs whose power supply is controlled by the master ECU 10.

The notification ECU 50 may be, for example, a meter ECU, a navigation ECU, or a telematics control unit (TCU). When a meter ECU is used as the notification ECU 50, the assembly diagnosis result can be notified to the user using a meter display. When a navigation ECU is used as the notification ECU 50, the assembly diagnosis result can be notified to the user via the navigation display. When a TCU is used as the notification ECU 50, the assembly diagnosis results can be wirelessly transmitted from the TCU to an external tool such as a diagnosis device, and notified to the user by the diagnosis device. The other configurations of the assembly diagnosis system according to the second embodiment are similar to those of the assembly diagnosis system according to the first embodiment, and therefore will be omitted.

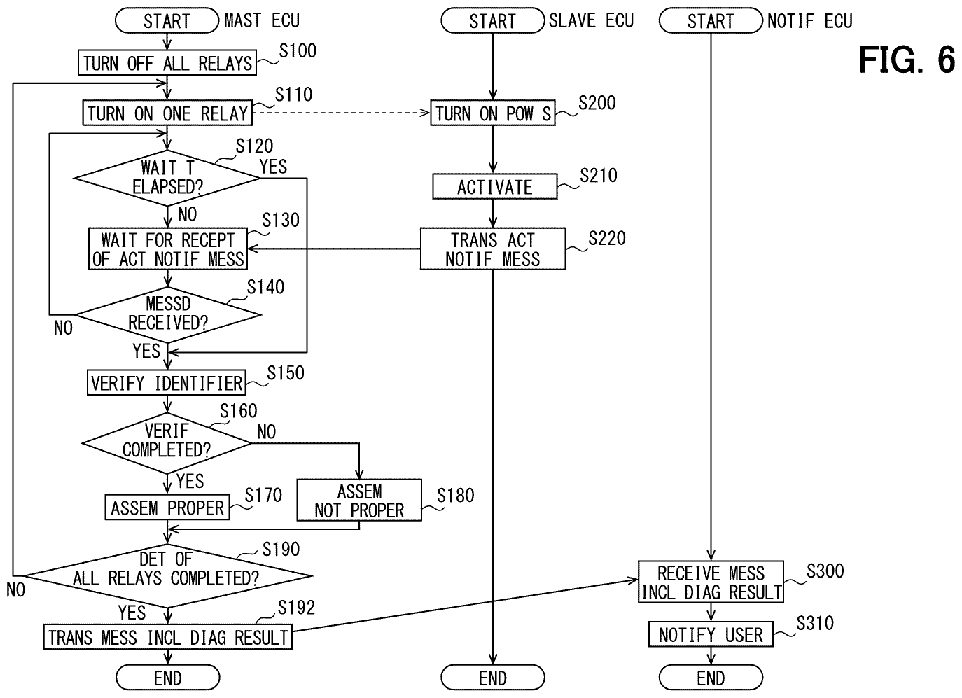

FIG. 6 is a flowchart showing an example of an diagnosis process executed in an assembly diagnosis system according to the present embodiment. Among the processes in the master ECU 10, the processes from steps S100 to S190 and the processes from steps S200 to S220 in the slave ECUs 30 and 40 are similar to the processes from steps S100 to S190 and steps S200 to S220, respectively, described in the flowchart of FIG. 2, and therefore will be omitted here.

In this embodiment, when the master ECU 10 determines in step S190 that the determination as to whether or not the assembly is proper for all of the relay switches 14, 16, 18 has been completed, the master ECU 10 executes the process of step S192. In step S192, the master ECU 10 transmits a message including the assembly diagnosis result to the notification ECU 50 via the communication network 22.

In step S300, the notification ECU 50 receives a message including the assembly diagnosis result via the communication network 22. Then, in step S310, the notification ECU 50 notifies the user of the assembly diagnosis result by displaying the assembly diagnosis result on a display or wirelessly transmitting the assembly diagnosis result to an external diagnosis device.

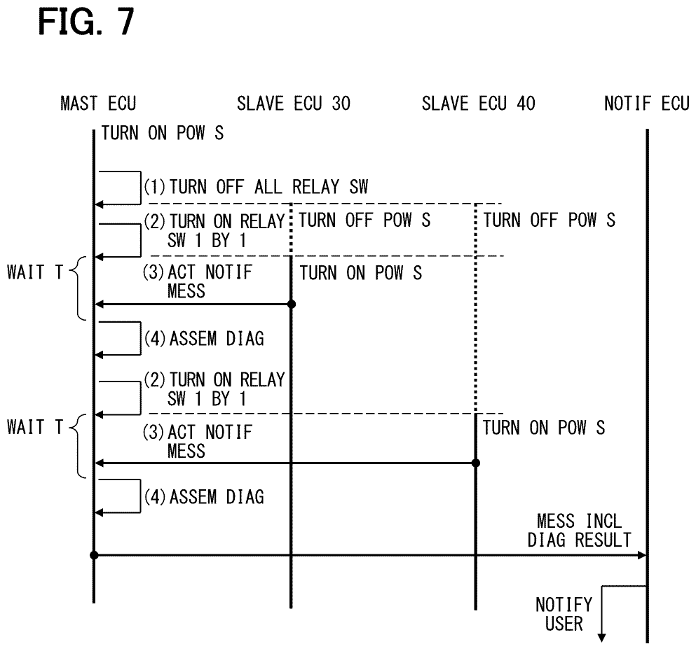

FIG. 7 is a time chart showing an example of the operations of the master ECU 10, the first and second slave ECUs 30, 40, and the notification ECU 50 in accordance with the process of the flowchart of FIG. 6. As shown in FIG. 7, the master ECU 10 diagnoses whether or not all of the slave ECUs 30, 40 have been properly assembled while sequentially turning on all of the relay switches 14, 16, 18 one by one, in the same manner as in the time chart of FIG. 4.

In this embodiment, after the completion of the diagnosis of whether or not all of the slave ECUs 30, 40 have been properly assembled, the master ECU 10 transmits a message including the assembly diagnosis result to the notification ECU 50. The notification ECU 50 receives this message and notifies the user of the assembly diagnosis result included in the message.

### Third Embodiment

Next, an assembly diagnosis system and an assembly diagnosis method according to a second embodiment of the present disclosure will be described with reference to the drawings.

In the first and second embodiments, the master ECU 10 determines whether the assembly of each slave ECU 30, 40 has been performed properly, and stores the assembly diagnosis result as the determination result in the master ECU 10 or transmits the assembly diagnosis result to the notification ECU 50.

Here, if another ECU connected to the communication network 22 needs to communicate with at least one of the slave ECUs 30, 40 and transmits a message to the corresponding slave ECU 30, 40. At this time, if the electric power is not being supplied to the slave ECUs 30, 40, the slave ECUs 30, 40 cannot respond to the transmitted message. In this case, the other ECUs are unable to communicate with the corresponding slave ECU 30, 40, and may erroneously determine that some anomaly has occurred in the corresponding slave ECU 30, 40.

Therefore, in this embodiment, based on the relationship between the relay switches 14, 16, 18 and the identifiers of the slave ECUs 30, 40 linked to each other during the assembly diagnosis, the master ECU 10 is configured to repeatedly (for example, periodically) transmit a message including the on/off state of each relay switch 14, 16, 18 and the identifiers of the slave ECUs 30, 40 linked to the relay switches 14, 16, 18 to other ECUs connected to the communication network 22. Furthermore, when other ECUs connected to the communication network 22 recognize that the power source of the slave ECU 30, 40 with which the other ECUs are attempting to communicate is in the off state based on the on/off state of the relay switches 14, 16, 18 linked to the identifiers of the slave ECUs 30, 40 included in the message, the other ECUs are configured to disable the anomaly determination function for the slave ECU 30, 40. Thus, it is possible to prevent the other ECUs from erroneously determining that the slave ECUs 30, 40 are anomaly because the power source to the slave ECUs 30, 40 is in the off state.

The assembly diagnosis system according to this embodiment can be configured similarly to the assembly diagnosis system according to the first embodiment or the assembly diagnosis system according to the second embodiment, and therefore a description of the configuration will be omitted.

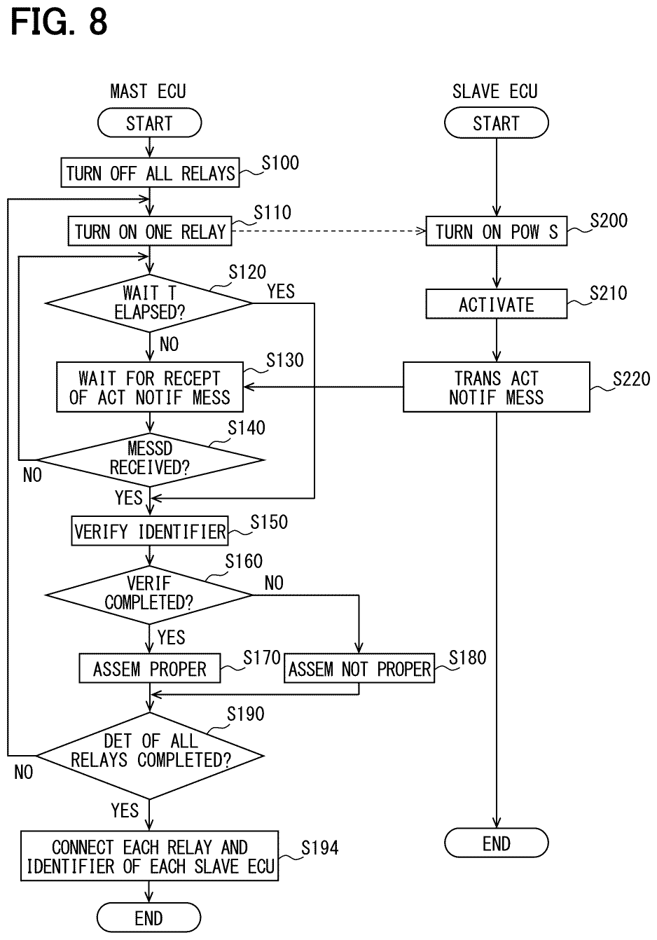

FIG. 8 is a flowchart showing an example of an diagnosis process executed in an assembly diagnosis system according to the present embodiment. Among the processes in the master ECU 10, the processes from steps S100 to S190 and the processes from steps S200 to S220 in the slave ECUs 30 and 40 are similar to the processes from steps S100 to S190 and steps S200 to S220, respectively, described in the flowchart of FIG. 2, and therefore will be omitted here.

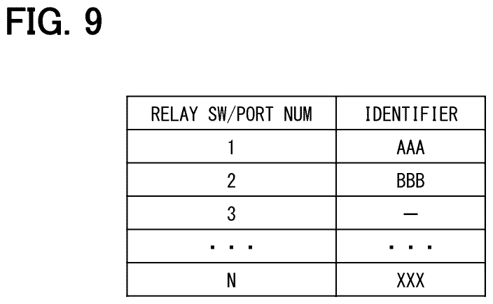

In step S194, the master ECU 10 stores the diagnosis factors of the slave ECUs 30, 40 that have been diagnosed as being properly assembled with respect to each of the relay switches 14, 16, 18 to be linked to the diagnosis factors. For example, as shown in FIG. 9, the master ECU 10 can store the identifiers of the slave ECUs 30, 40 that have been properly assembled, to be linked to the numbers of the respective relay switches 14, 16, 18.

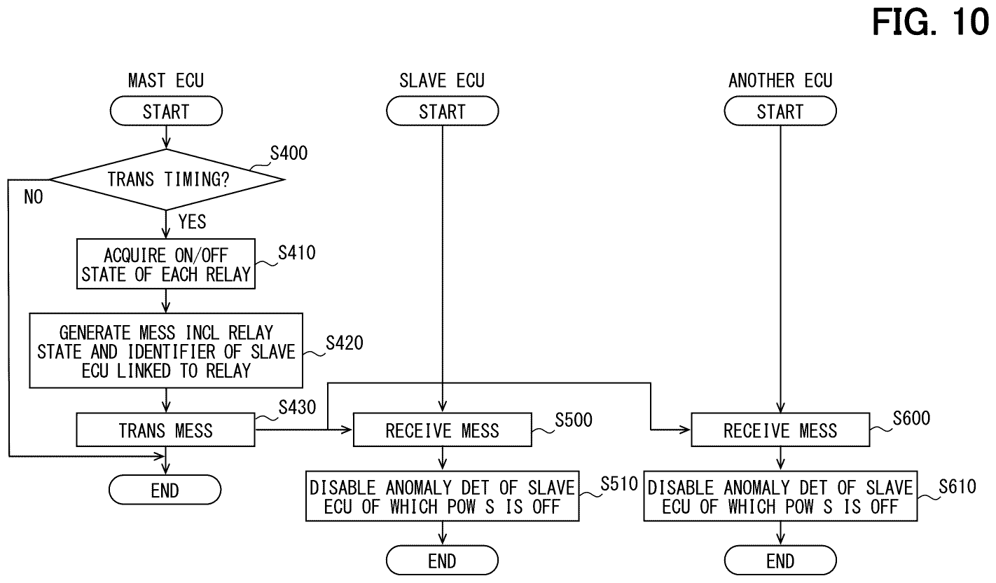

When each ECU mounted on the vehicle operates, the process shown in the flowchart of FIG. 10 is executed. The master ECU 10 executes the process shown in the flowchart of FIG. 10 at a predetermined cycle.

In step S400, the master ECU 10 determines whether it is time to transmit a message including the on/off state of each relay switch 14, 16, 18 and the identifier of the slave ECU 30, 40 linked to that relay switch 14, 16, 18. For example, the master ECU 10 can transmit a message periodically at a predetermined cycle. In this case, the master ECU 10 determines that it is time to transmit a message when the time equivalent to a predetermined cycle has elapsed since the previous message was transmitted. Alternatively, the master ECU 10 may transmit the message when the on/off state of at least one of the relay switches 14, 16, 18 (i.e., the on/off state of the power source to the slave ECUs 30, 40) changes. In this case, the master ECU 10 determines that it is time to transmit a message when the on/off state of at least one of the relay switches 14, 16, 18 has changed. If it is determined in step S400 that it is time to transmit, the master ECU 10 proceeds to step S410. On the other hand, if it is determined that it is not the transmission timing, the master ECU 10 ends the process shown in the flowchart of FIG. 10.

In step S410, the master ECU 10 acquires the on/off states of the relay switches 14, 16, and 18. In the next step S420, the master ECU 10 generates a message including the on/off state of each of the relay switches 14, 16, 18 and the identifiers of the slave ECUs 30, 40 linked to the relay switches 14, 16, 18. Then, in step S430, the master ECU 10 transmits the generated message to the ECUs connected to the communication network.

The message transmitted from the master ECU 10 is received by the slave ECUs 30, 40 and other ECUs (such as the notification ECU 50) in steps S500 and S600, respectively. The slave ECUs 30, 40 that have received this message disable in step S510 the anomaly determination function for the slave ECUs 30, 40 to which the relay switches 14, 16, 18 are in the off state and the electric power is not being supplied. Similarly, in step S610, the other ECUs that has received this message also disable the anomaly determination functions for the slave ECUs 30, 40 to which the electric power is not being supplied.

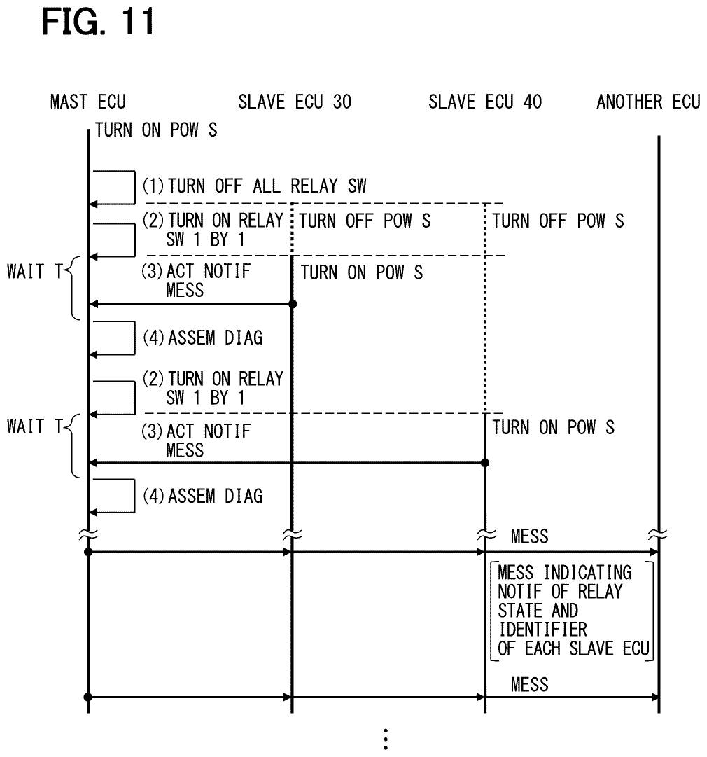

FIG. 11 is a time chart showing an example of the operations of the master ECU 10, the first and second slave ECUs 30, 40, and the other ECUs in accordance with the process of the flowchart of FIGS. 8 and 10. As shown in FIG. 11, the master ECU 10 diagnoses whether or not all of the slave ECUs 30, 40 have been properly assembled while sequentially turning on all of the relay switches 14, 16, 18 one by one, in the same manner as in the time chart of FIG. 4.

In this embodiment, when each ECU assembled in the vehicle operates, the master ECU 10 transmits a message including the on/off state of each relay switch 14, 16, 18 and the identifier of the slave ECU 30, 40 linked to the relay switch 14, 16, 18 to each ECU connected to the communication network 22 at each predetermined transmission timing. In response to receiving this message, each ECU disables the anomaly determination function for the slave ECU to which the electric power is not being supplied. Thus, it is possible to prevent the other ECUs from erroneously determining that the slave ECUs 30, 40 are anomaly because the power source to the slave ECUs 30, 40 is in the off state.

### Fourth Embodiment

Next, an assembly diagnosis system and an assembly diagnosis method according to a fourth embodiment of the present disclosure will be described with reference to the drawings.

In the above-described first embodiment, an example has been described in which the slave ECUs 30, 40 start the activation process when the master ECU 10 turns on the corresponding relay switches 14, 16, 18 to start the electric power supply.

However, in recent years, ECUs that support partial network management, which is not activated simply by being supplied with the electric power but becomes a so-called hibernation state, and starts the activation process in response to the reception of the activation request message, are becoming more common. When ECUs compatible with such partial network management are adopted as the slave ECUs 30, 40, in order for the master ECU 10 to receive the activation notification message from the slave ECUs 30, 40, in addition to turning on the relay switches 14, 16, 18, it is necessary for the master ECU 10 to transmit the activation request message to the corresponding slave ECU 30, 40.

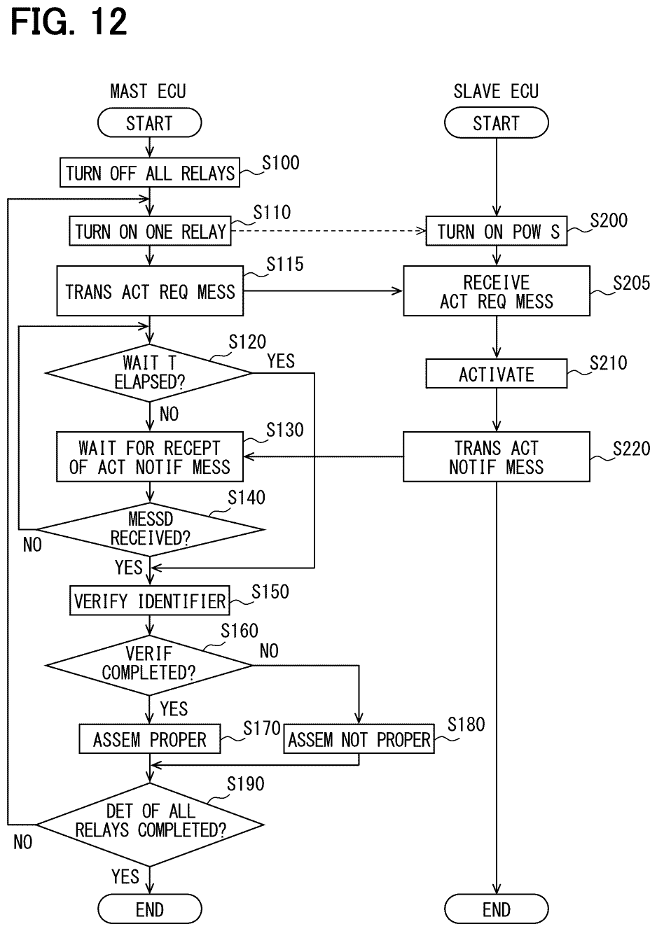

Therefore, in this embodiment, as shown in the flowchart of FIG. 12, the master ECU 10 is configured to turn on one of the relay switches 14, 16, 18 in a predetermined order in step S110, and then to transmit the activation request message to the first and second slave ECUs 30, 40 in step S115.

The first and second slave ECUs 30, 40 start receiving the power supply in step S200, and then, when the first and second slave ECUs 30, 40 receive the activation request message from the master ECU 10 in step S205, the first and second slave ECUs 30, 40 start the activation process in step S210. When the power supply is started, the slave ECUs 30 and 40 becomes the hibernation state in which all functions except for the function of receiving the activation request message are suspended.

In the flowchart of FIG. 12, the process other than the processes of the master ECU 10 and the first and second slave ECUs 30, 40 described above is similar to the processes of the master ECU 10 and the first and second slave ECUs 30, 40 in the flowchart of FIG. 2, for example, and therefore description thereof will be omitted.

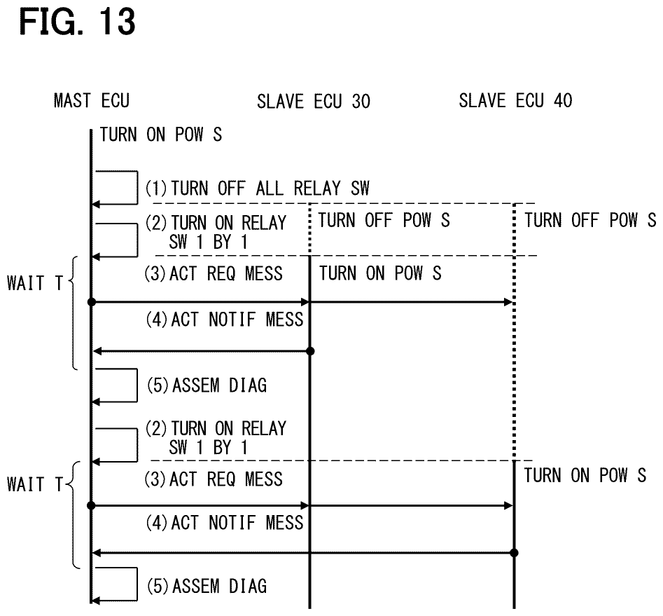

FIG. 13 is a time chart showing an example of the operation of the master ECU 10 and the first and second slave ECUs 30, 40 in accordance with the process of the flowchart of FIG. 12. As shown in FIG. 13, the master ECU 10 transmits the activation request message to the first and second slave ECUs 30, 40 while sequentially turning on all of the relay switches 14, 16, 18 one by one.

For example, as shown in FIG. 13, when the master ECU 10 turns on the first relay switch 14 corresponding to the first slave ECU 30, only the first slave ECU 30 is supplied with the electric power. Therefore, when the master ECU 10 transmits the activation request message, only the first slave ECU 30 can receive the activation request message. Then, the first slave ECU 30 starts the activation process in response to receiving the activation request message. When the activation process is completed, the first slave ECU 30 transmits the activation notification message to the master ECU 10.

Furthermore, when the master ECU 10 turns on the second relay switch 16 corresponding to the second slave ECU 40, the second slave ECU 40 is supplied with the electric power. At this time, when the master ECU 10 transmits the activation request message, the second slave ECU 40 can receive the activation request message. Then, the second slave ECU 40 starts the activation process in response to receiving the activation request message. On the other hand, the first slave ECU 30 also receives the activation request message from the master ECU 10, but since the first slave ECU 30 has already been activated, the first slave ECU 30 does not transmit the activation notification message.

### Fifth Embodiment

Next, an assembly diagnosis system and an assembly diagnosis method according to a fifth embodiment of the present disclosure will be described with reference to the drawings.

In each of the above-described embodiments, an example in which an optional ECU is not connected has been described. In contrast, in this embodiment, an example will be described in which an optional ECU is connected as one of the slave ECUs to which the master ECU 10 controls whether or not to supply the electric power.

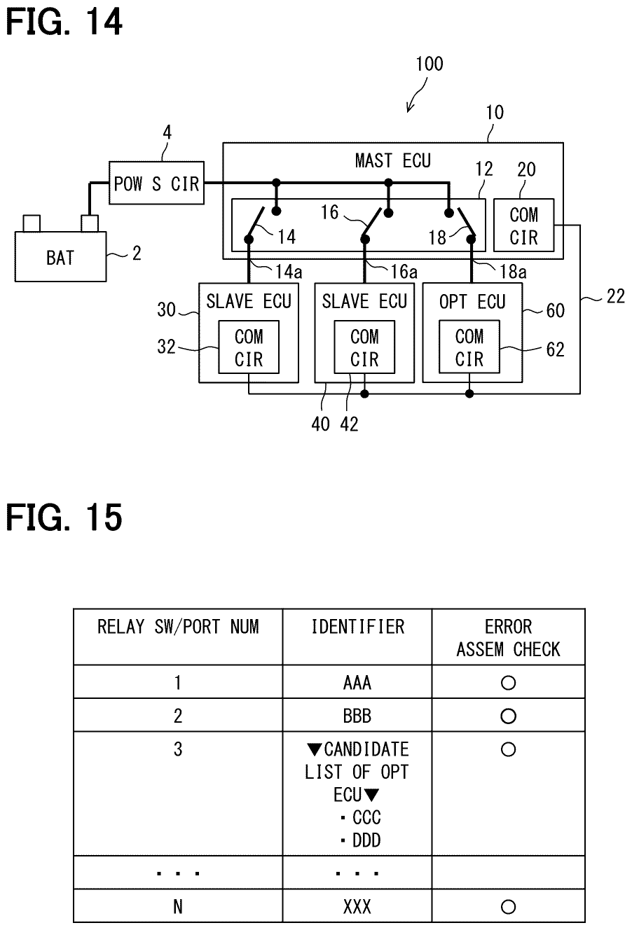

As shown in FIG. 14, in this embodiment, an optional ECU 60 is connected to a third power port 18a linked to the third relay switch 18 of the relay circuit 12. The communication circuit 62 of the optional ECU 60 has a message transmission and reception function similar to that of the communication circuit 20 of the master ECU 10. Therefore, the optional ECU 60 can also use the communication circuit 62 to transmit and receive various messages to and from each ECU connected to the communication network 22.

The type of the optional ECU 60 to be connected may vary depending on which optional function is selected by the user and/or depending on the vehicle model and the vehicle grade. In addition, optional ECUs may be added through updates after the vehicle is sold to the user.

Therefore, different from the first and second slave ECUs 30, 40, as shown in FIG. 15, a candidate list for the optional ECU 60 is stored to be linked to the third relay switch 18 and/or the third power port 18a. If the activation notification message transmitted from the optional ECU 60 includes any of the identifiers included in the candidate list, the master ECU 10 diagnoses that the assembly is proper. Thus, it is possible to perform the assembly diagnosis regardless of the type of optional ECU 60 that is connected as the optional ECU 60.

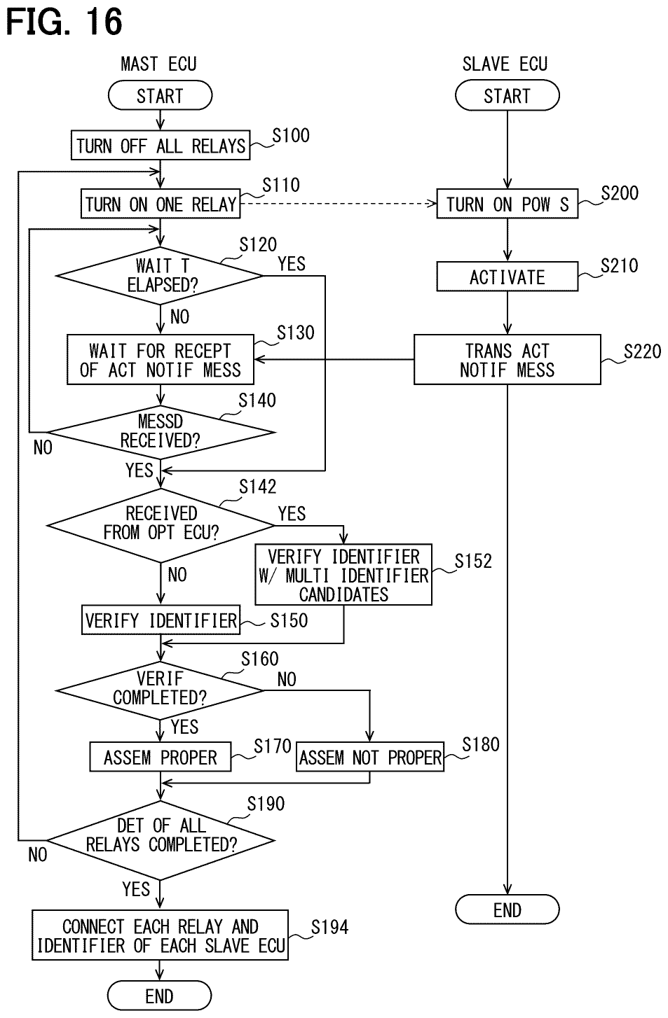

FIG. 16 is a flowchart showing an example of an diagnosis process executed in an assembly diagnosis system according to the present embodiment. Among the processes in the master ECU 10, the processes from steps S100 to S190 other than steps S142 and S152 and the processes from steps S200 to S220 in the slave ECUs 30, 40 and 60 are similar to the processes from steps S100 to S190 and steps S200 to S220, respectively, described in the flowchart of FIG. 2, and therefore will be omitted in detail here.

In step S142 of the flowchart in FIG. 16, when the master ECU 10 receives the activation notification message from any of the slave ECUs 30, 40, 60, the master ECU 10 determines whether the activation notification message is received from the optional ECU 60 or not. For example, when the third relay switch 18 for supplying the electric power to the optional ECU 60 is turned on in step S120, and when the master ECU 10 receives the activation notification message in step S140, the master ECU 10 can determine that the activation notification message is received from the optional ECU 60.

If it is determined in step S142 that the activation notification message is not received from the optional ECU 60, the master ECU 10 proceeds to the process of step S150. In step S150, similar to the above-described embodiments, the master ECU 10 refers to information preliminarily stored in the storage indicating the identifier of the slave ECU 30, 40 that is linked to the number of the relay switch 14, 16 or the number of the power port 14a, 16a, and specifies one of the identifiers of the slave ECUs 30, 40 that corresponds to one of the relay switches 14, 16 that has been turned on in step S120. Then, the master ECU 10 verifies specified one of the identifiers of the slave ECUs 30 and 40 with the identifier included in the received activation notification message.

If it is determined in step S142 that the activation notification message is received from the optional ECU 60, the master ECU 10 proceeds to the process of step S152. In step S152, the master ECU 10 specifies a candidate list of the identifier of the option ECUs 60 that is stored in the storage and that is linked to the number of the third relay switch 18 or the number of the third power port 18a. Then, the master ECU 10 verifies the candidate list of the identifier of the specified optional ECU 60 with the identifier included in the received activation notification message. At this time, if the identifier included in the activation notification message matches any of the identifiers included in the candidate list, the master ECU 10 determines in step S160 that the identifier matching result in step S152 is proper. The candidate list of identifiers of the optional ECUs 60 may be stored in advance, or may be updated through communication with an external server.

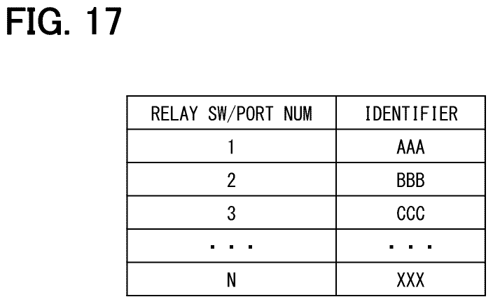

Then, in step S194, the master ECU 10 stores the diagnosis factor of the slave ECUs 30, 40, 60 that have been diagnosed as being properly assembled, to be linked to each of the relay switches 14, 16, 18, as shown in FIG. 17. The stored diagnosis factor includes the matched diagnosis factor (i.e., learned diagnostics) of the optional ECU 60. Therefore, as described in the third embodiment, based on the relationship between the relay switches 14, 16, 18 and the identifiers of the slave ECUs 30, 40, 60 linked to each other during the assembly diagnosis, the master ECU 10 can repeatedly transmit a message including the on/off state of each relay switch 14, 16, 18 and the identifiers of the slave ECUs 30, 40, 60 linked to the relay switches 14, 16, 18 to other ECUs connected to the communication network 22.

The present disclosure is described with multiple embodiments as described above. However, the present disclosure is not limited to the above-mentioned embodiments, and may be variously modified within the spirit and scope of the present disclosure.

For example, in each of the above-described embodiments, the master ECU 10 functions as a diagnosis unit that performs the assembly diagnosis on each of the slave ECUs 30, 40, 60. However, the diagnosis unit does not necessarily have to be provided in the master ECU 10. For example, other ECUs or diagnosis devices connected to the communication network 22 may be configured to function as a diagnosis unit.

In the fifth embodiment described above, the identifier included in the activation notification message is verified with one identifier for normal slave ECUs 30, 40, and with a candidate list of multiple identifiers for optional ECUs. Alternatively, the normal slave ECUs 30, 40 may be verified with a candidate list of a plurality of identifiers, and if the normal slave ECUs 30, 40 match any of the identifiers in the candidate list, it may be determined that the assembly is proper. For example, a plurality of grades may be set in the vehicle, and the control contents of the slave ECUs 30, 40 for the same control target object may be different depending on the grade of the vehicle. In such a case, it is possible to store, as a candidate list, the identifiers of the slave ECUs 30, 40 that have different control contents for the same control target object. Thus, it is possible to perform the perform the assembly diagnosis on a group basis when the slave ECUs 30, 40 that have different control contents for the same control target object are defined as the same group.

The system and the method thereof described in the present disclosure may be implemented by a special purpose computer, which includes a processor programmed to provide one or more functions performed by computer programs. The systems and methods described in this disclosure may be implemented using a dedicated hardware logic circuit. The system, and the method thereof described in the present disclosure may be implemented by one or more dedicated computers configured by a combination of a processor that executes a computer program and one or more hardware logic circuitries. For example, some or all of the functions of the master ECU 10 may be realized as hardware. A configuration in which certain function is implemented by hardware logic circuitry includes a configuration in which the function is implemented using one or more ICs or the like. As the processor (i.e., arithmetic core), a CPU, an MPU, a GPU, a DFP (Data Flow Processor), or the like can be adopted. Some or all of the functions of the master ECU 10 may be realized using any of a system-on-chip (i.e., SoC), an integrated circuit (i.e., IC), and a field-programmable gate array (i.e., FPGA). The aspect of the IC also includes ASIC (i.e., Application Specific Integrated Circuit). The computer program described above may be stored in a computer-readable non-transitory tangible storage medium as instructions to be executed by a computer. As a storage medium for storing the computer program, a hard disk drive (i.e., HDD), a solid state drive (i.e., SSD), a flash memory, or the like can be adopted. The scope of the present disclosure also includes programs for causing a computer to function as the master ECU 10, non-transitory tangible storage mediums such as semiconductor memories which store these programs, and other aspects.

The present disclosure discloses multiple technical ideas listed below and multiple combinations thereof. The combinations of a plurality of technical features described below may apply not only to the assembly diagnosis system 100 but also to the assembly diagnosis method and the assembly diagnosis program.

### Technical Feature 1

An assembly diagnosis system includes: at least one of (i) a circuit and (ii) a processor having a memory storing computer program code. The at least one of the circuit and the processor having the memory is configured to cause the assembly diagnosis system to provide at least one of: a master ECU; at least one slave ECU that transmits an activation notification message including an identifier of the at least one slave when the at least one slave ECU is activated; a switch provided in a power supply line of the at least one slave ECU; and a diagnosis unit. The master ECU has a function of turning on and off the switch, and can control whether or not electric power is supplied to the at least one slave ECU. When the at least one slave ECU receives electric power supply and is activated, the at least one slave ECU transmits the activation notification message to a communication network to which the master ECU and the at least one slave ECU are connected. The diagnosis unit diagnoses whether or not the at least one slave ECU has been properly assembled based on the activation notification message transmitted to the communication network.

### Technical Feature 2

In the assembly diagnosis system described in technical feature 1, the diagnosis unit stores an identifier of the at least one slave ECU to be assembled properly, and diagnoses whether the at least one slave ECU has been assembled properly, based on a verification result between a stored identifier and an identifier included in the activation notification message.

### Technical Feature 3

In the assembly diagnosis system described in technical feature 1, the master ECU is configured to be able to control whether or not an electric power is supplied to a plurality of slave ECUs, each of which has a different role; the master ECU executes an electric power supply to the plurality of slave ECUs one by one at a predetermined cycle and in a predetermined order when diagnosing by the diagnosis unit; and the diagnosis unit individually diagnoses whether or not each of the plurality of slave ECUs has been properly assembled, based on activation notification messages transmitted from the plurality of slave ECUs, respectively.

### Technical Feature 4

In the assembly diagnosis system described in technical feature 3, the diagnosis unit stores an identifier of each of the slave ECUs to be assembled as one of the slave ECUs corresponding to the predetermined order when the master ECU executes the electric power supply to the plurality of slave ECUs one by one in the predetermined order; and the diagnosis unit individually diagnoses whether or not each of the slave ECUs has been assembled properly, based on the verification result between a stored identifier of each of the slave ECUs and an identifier included in the activation notification message that is transmitted in the predetermined order.

### Technical Feature 5

In the assembly diagnosis system described in technical feature 2 or 4, the diagnosis unit determines that the at least one slave ECU has not been properly assembled when the diagnosis unit cannot receive the activation notification message from the at least one slave ECU, or when an identifier included in the activation notification message does not match a stored identifier.

### Technical Feature 6

In the assembly diagnosis system described in technical feature 5, the diagnosis unit stores one identifier as an identifier to be verified with an identifier included in the activation notification message; and the diagnosis unit diagnoses that the at least one slave ECU that transmits the activation notification message is not assembled properly when the identifier included in the activation notification message does not match the stored identifier.

### Technical Feature 7

In the assembly diagnosis system described in technical feature 5, the diagnosis unit stores a plurality of identifier candidates as an identifier to be verified with an identifier included in the activation notification message; and the diagnosis unit diagnoses that the at least one slave ECU that transmits the activation notification message is not assembled properly when the identifier included in the activation notification message does not match any of stored identifier candidates.

### Technical Feature 8

In the assembly diagnosis system described in any one of technical features 1 to 7, the at least one slave ECU transmits the activation notification message in response to being activated by receiving electric power supply.

### Technical Feature 9

In the assembly diagnosis system described in any one of technical features 1 to 7, the master ECU transmits an activation request message to the at least one slave ECU after starting an electric power supply to the at least one slave ECU; and the at least one slave ECU is activated in response to receiving the activation request message from the master ECU and transmits the activation notification message after receiving the electric power supply.

### Technical Feature 10

The assembly diagnosis system described in any one of technical features 1 to 9 further includes: a notification unit that notifies a user of a diagnosis result by the diagnosis unit.

### Technical Feature 11

The assembly diagnosis system described in technical feature 10 further includes: a notification ECU connected to the communication network and having a user notification function. The master ECU provides a function as the diagnosis unit; and the notification ECU receives a message including a diagnosis result from the master ECU, and notifies the user of the diagnosis result as the notification unit.

### Technical Feature 12

In the assembly diagnosis system described in any one of technical features 1 to 11, the master ECU links the switch with an identifier of the at least one slave ECU to which the electric power supply is controlled by the switch, based on a diagnosis result by the diagnosis unit; and the master ECU repeatedly transmits a message including an on and off state of the switch and the identifier of the at least one slave ECU linked to the switch to the communication network.

### Technical Feature 13

The assembly diagnosis system described in technical feature 12, further includes: at least one diagnosis ECU that is connected to the communication network and has a communication diagnosis function for determining whether another ECU connected to the communication network can communicate normally. The diagnosis ECU disables communication diagnosis of the at least one slave ECU in which the switch is in an off state, based on the message periodically transmitted from the master ECU.

### Technical Idea 14

In the assembly diagnosis system described in any one of technical features 1 to 13, the master ECU and the at least one slave ECU are both mounted in a vehicle; and the diagnosis unit diagnoses whether or not the at least one slave ECU has been properly mounted in the vehicle.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An assembly diagnosis system comprising:
a master ECU;
at least one slave ECU that transmits an activation notification message including an identifier of the at least one slave ECU when the at least one slave ECU is activated;
a switch provided in an electric power supply line of the at least one slave ECU; and
a diagnosis unit, wherein:
the master ECU has a function of turning on and off the switch, and can control whether an electric power is supplied to the at least one slave ECU;
the at least one slave ECU transmits the activation notification message to a communication network to which the master ECU and the at least one slave ECU are connected when the at least one slave ECU receives an electric power supply and is activated; and
the diagnosis unit diagnoses whether or not the at least one slave ECU has been properly assembled based on the activation notification message transmitted to the communication network.

2. The assembly diagnosis system according to claim 1, wherein:
the diagnosis unit stores an identifier of the at least one slave ECU to be assembled properly, and diagnoses whether the at least one slave ECU has been assembled properly, based on a verification result between a stored identifier and an identifier included in the activation notification message.

3. The assembly diagnosis system according to claim 1, wherein:
the at least one slave ECU includes a plurality of slave ECUs;
the master ECU is configured to be able to control whether an electric power is supplied to the plurality of slave ECUs, each of which has a different function;
the master ECU executes an electric power supply to the plurality of slave ECUs one by one at a predetermined cycle and in a predetermined order when diagnosing by the diagnosis unit; and
the diagnosis unit individually diagnoses whether each of the plurality of slave ECUs has been properly assembled, based on the activation notification message transmitted from each of the plurality of slave ECUs, respectively.

4. The assembly diagnosis system according to claim 3, wherein:
the diagnosis unit stores an identifier of each of the slave ECUs to be assembled properly as one of the slave ECUs corresponding to the predetermined order when the master ECU executes the electric power supply to the plurality of slave ECUs one by one in the predetermined order; and
the diagnosis unit individually diagnoses whether each of the slave ECUs has been assembled properly, based on a verification result between a stored identifier of each of the slave ECUs and an identifier included in the activation notification message that is transmitted in the predetermined order.

5. The assembly diagnosis system according to claim 2, wherein:
the diagnosis unit determines that the at least one slave ECU has not been properly assembled when the diagnosis unit cannot receive the activation notification message from the at least one slave ECU, or when an identifier included in the activation notification message does not match a stored identifier.

6. The assembly diagnosis system according to claim 5, wherein:
the diagnosis unit stores one identifier as an identifier to be verified with an identifier included in the activation notification message; and
the diagnosis unit diagnoses that the at least one slave ECU that transmits the activation notification message is not assembled properly when the identifier included in the activation notification message does not match a stored one identifier.

7. The assembly diagnosis system according to claim 5, wherein:
the diagnosis unit stores a plurality of identifier candidates as an identifier to be verified with an identifier included in the activation notification message; and
the diagnosis unit diagnoses that the at least one slave ECU that transmits the activation notification message is not assembled properly when the identifier included in the activation notification message does not match any of stored identifier candidates.

8. The assembly diagnosis system according to claim 1, wherein:
the at least one slave ECU transmits the activation notification message in response to being activated by receiving electric power supply.

9. The assembly diagnosis system according to claim 1, wherein:
the master ECU transmits an activation request message to the at least one slave ECU after starting an electric power supply to the at least one slave ECU; and
the at least one slave ECU is activated in response to receiving the activation request message from the master ECU and transmits the activation notification message after receiving the electric power supply.

10. The assembly diagnosis system according to claim 1, further comprising:
a notification unit that notifies a user of a diagnosis result by the diagnosis unit.

11. The assembly diagnosis system according to claim 10, further comprising:
a notification ECU connected to the communication network and having a user notification function, wherein:
the master ECU provides a function as the diagnosis unit; and
the notification ECU receives a message including a diagnosis result from the master ECU, and notifies the user of the diagnosis result as the notification unit.

12. The assembly diagnosis system according to claim 1, wherein:
the master ECU links the switch with an identifier of the at least one slave ECU to which the electric power supply is controlled by the switch, based on a diagnosis result by the diagnosis unit; and
the master ECU repeatedly transmits a message including an on and off state of the switch and the identifier of the at least one slave ECU linked to the switch to the communication network.

13. The assembly diagnosis system according to claim 12, further comprising:
at least one diagnosis ECU that is connected to the communication network, and has a communication diagnosis function for determining whether another ECU connected to the communication network can communicate normally, wherein:
the diagnosis ECU disables the communication diagnosis function of the at least one slave ECU in which the switch is in an off state, based on the message periodically transmitted from the master ECU.

14. The assembly diagnosis system according to claim 1, wherein:
the master ECU and the at least one slave ECU are both mounted in a vehicle; and
the diagnosis unit diagnoses whether the at least one slave ECU has been properly mounted in the vehicle.

15. The assembly diagnosis system according to claim 1, further comprising:
at least one of (i) a circuit and (ii) a processor having a memory storing computer program code, wherein:
the at least one of the circuit and the processor having the memory is configured to cause the assembly diagnosis system to provide at least one of: the master ECU; the at least one slave ECU; the switch; and the diagnosis unit.

16. An assembly diagnosis method comprising:
supplying an electric power to a slave ECU by a master ECU turning on a switch provided in a power supply line of the slave ECU;
transmitting an activation notification message including an identifier of the slave ECU to a communication network to which the master ECU and the slave ECU are connected when the slave ECU receives electric power supply and is activated; and
diagnosing whether the slave ECU has been properly assembled based on the activation notification message transmitted to the communication network.
